(19) United States
(12) Patent Application Publication
(10) Pub. No.: US 2012/0042776 A1
(43) Pub. Date: Feb. 23, 2012

(54) Piston Guide Element

(75) Inventors: Oliver Gaertner, Abstatt (DE); Wolfgang Schuller, Cleebronn (DE); Michael Schuessler, Seckach (DE); Daniel Gosse, Berlin (DE)

(73) Assignee: Robert Bosch GmbH, Stuffgart (DE)

(21) Appl. No.: 13/213,041

(22) Filed: Aug. 18, 2011

(30) Foreign Application Priority Data
Aug. 19, 2010 (DE) 10 2010 039 507.2

(51) Int. Cl. F16J 1/00; B23P 15/00

(52) U.S. Cl. 92/172; 29/888.02

(57) ABSTRACT

A piston pump, in particular a hydraulic piston pump, includes a piston movable in a piston housing and a piston guide element, arranged between the piston housing and the piston, for guiding and/or mounting the piston. The piston guide element is configured as a coating applied fixedly at least to an inner surface area of the piston housing or to an outer surface area of the piston.

This application claims priority under 35 U.S.C. §119 to German patent application no. DE 10 2010 039 507.2, filed Aug. 19, 2010 in Germany, the disclosure of which is incorporated herein by reference in its entirety.

### BACKGROUND

The disclosure relates to a piston pump, in particular a hydraulic piston pump, with a piston movable in a piston housing and with a piston guide element, arranged between the piston housing and the piston, for guiding and/or mounting the piston. The disclosure relates, furthermore, to a method for producing a piston pump and also to a piston guide element of a piston pump of this type and to a vehicle brake system having a piston pump.

Piston guide elements of hydraulic piston pumps for the guidance of pistons mounted displaceably in a piston housing usually bear axially against the piston housing in the longitudinal direction, specifically between an inner surface area of the piston housing and an outer surface area of the piston. As a rule, the piston is guided and supported essentially at two portions on the inner surface of the housing.

On the one hand, in this case, a high pressure-side sealing ring, held fixedly on the piston, functions as a first guide element. This first guide element is also designated as a movable bearing, since the high pressure-side sealing ring moves to and fro, together with the piston, in relation to the housing.

On the other hand, a guide ring, preferably made from plastic, and as a component originally present separately, is pressed in on the low pressure side as a second guide element between the housing and the piston. This pressed-in guide ring bears fixedly against the inner surface of the housing and is therefore also designated as a fixed or second bearing.

DE 10 2007 052 664 A1 discloses as a guide element a guide ring for an axially reciprocally adjustable pump piston or pump rod of a piston pump. The guide ring is in this case designed as a radial damping element for the damping of radial impacts of the pump piston or pump rod.

Furthermore, DE 101 23 038 A1 discloses a guide ring arrangement for the radial guidance of a piston of a piston pump of a hydraulic vehicle brake system. The guide ring arrangement is arranged in the region of an eccentric-side end of the piston. In this case, a guide ring made from an, in particular, plastically deformable plastic is arranged in a groove forming an annular seat, next to a sealing ring arranged on a pressure side of the guide ring. An end face, facing away from the pressure side, of the guide ring and an assigned groove cheek face are formed conically. When pressure acts upon the sealing ring, the conical end face causes a contraction in the diameter of the guide ring and consequently an automatic reduction in size of guidance play of the guide ring. A gap between the piston and the guide ring is avoided permanently, even in the event of a wear of the guide ring, and therefore extrusion of the sealing ring into such a gap under the action of high pressure is prevented.

The object of the disclosure is to make available a piston guide element which, on the one hand, has low wear and therefore long service life and, on the other hand, can be produced cost-effectively and can be integrated in a piston pump in a space-saving way.

### SUMMARY

According to the disclosure, in a piston pump, the piston guide element for guiding and/or mounting a piston movable in a piston housing is configured as a coating applied fixedly at least to an inner surface area of the piston housing or to an outer surface area of the piston.

The hydraulic piston pump designed thus according to the disclosure comprises a piston which is mounted retractably and extendably in an inner space, a bore, of a piston housing. The inner space of the housing is delimited by a wall having an inner surface area. Between the inner surface area of the piston housing and an outer surface area of the piston, a piston guide element according to the disclosure is arranged which supports and guides or mounts the piston during retraction into and extension out of the housing in what is known as a pumping movement.

When the piston is being extended out of the housing, a vacuum is built up in a pressure region in the inner space of the housing, and the piston sucks fluid into the pressure region via an inlet valve. When being retracted into the housing, the piston forces the fluid from the pressure region into a hydraulic system via an outlet valve for the purpose of performing work. This pressure region is sealed off, essentially fluid-tight, with respect to what is known as a low-pressure region, particularly by means of a sealing element. The piston guide element according to the disclosure may in this case be arranged in the pressure region and/or in the low-pressure region.

In the present context, a fluid is to be understood as meaning a gas and/or liquid, such as, for example, a mineral-based or glycol-based hydraulic fluid.

According to the disclosure, the piston guide element is formed as a coating which is very thin, as compared with a conventional guide ring. That is to say, the coating is configured as a thin layer or as a thin ply in relation to a guide ring according to the prior art.

This coating may be applied to the inner surface area of the piston housing and/or to the outer surface area of the piston. In this case, the coating is connected preferably fixedly to the corresponding surface area.

Fixed application is to be understood preferably as meaning a connection in which the piston guide element and the piston housing or the piston guide element and the piston form a unit and, particularly when the piston pump is being assembled and operated, remain firmly connected. Preferably, in the case of a cylindrical form of the piston and housing, the coating is configured in the form of a ring which surrounds or clads the piston or housing over a specific length portion.

If the coating is applied to the inner surface area of the piston housing, the piston bears with its outer surface area, preferably with an exact fit, against a piston-facing periphery of the coating and, during the pumping movement, slides past the periphery of the coating.

If, by contrast, the coating is applied to the outer surface area of the piston, the piston slides with the coating according to the disclosure, to be precise with a housing-facing periphery, past the inner surface area of the pump housing and comes to bear there, preferably with an exact fit.

It is also conceivable that the inner surface area of the piston housing and the outer surface area of the piston have a coating according to the disclosure. In such a case, the two coatings slide with their respective periphery past one another during a relative movement of the piston with respect to the housing. The piston is supported and guided and is therefore held in the desired positioning.

The coating according to the disclosure is preferably formed to be highly wear-resistant, in particular high-strength, in that a high-strength material is preferably used. Optimal wear protection for the mounting and the pump piston is thus made available; wear-resistant piston guidance in the piston housing is therefore ensured. The coating may be applied by means of any suitable coating method.

Advantageously, a piston guide element is made available which can be used, in particular, in hydraulic piston pumps which require a long running capacity or service life of the piston guide.

By the use according to the disclosure of a coating instead of a guide ring according to the prior art, in the present case a piston guide element is provided which requires only a very small installation space. The hydraulic piston pump can consequently be designed with smaller dimensions.

The coating, in particular, optimally utilizes the available construction space. This is of major importance, since the latest generations of hydraulic piston pumps make increasingly smaller installation spaces available because of a reduction in box volume, this also being reflected in a guidance length of the pump piston.

Advantageously, the piston guide element according to the disclosure in the form of a coating also brings about an increased guide length of the piston in the piston housing, since the coating can be applied over a larger length portion to the inner or the outer surface area of the piston housing or piston respectively.

Furthermore, the advantage of the features of the disclosure is that the piston can be guided directly in the inner space of the pump housing, and a guide ring in the form of an additional component and also a corresponding assembly step can be dispensed with, thus leading to a reduction in costs during the production process.

The coating according to the disclosure is advantageously formed from a high-strength plastic.

The plastic used is, in particular, resistant to organic and inorganic media and also to corrosion phenomena and therefore has high durability. Furthermore, the coating formed from high-strength plastic is very light, thus leading to a low weight of the piston pump. The plastic preferably has good frictional or sliding properties with the result that the piston is received and held axially displaceably in the housing without significant frictional losses.

The piston guide element may be formed in one piece, for example, as a “spray coating”. It can be connected to the inner surface area of the piston housing and/or to the outer surface area of the piston in a materially integral manner, such as by means of adhesive bonding. The coating can therefore be produced cost-effectively and, in the production process, simply has to be joined together with the piston or housing.

The plastic of the coating according to the disclosure is especially preferably a polyetherketone.

Advantageously, a polyetherketone is a high temperature-resistant thermoplastic which has high resistance to organic and inorganic chemicals and also hydrolysis resistance up to approximately 280° C. The density of the polyetherketone used preferably amounts to 1300 kg/m³, with the result that a high-strength plastic is made available.

Preferably, the piston guide element is formed from polyetheretherketone (PEEK) which has a melting temperature of approximately 335° C. A high-strength coating which is especially robust and wear-resistant is thereby made available.

Furthermore, the coating according to the disclosure is applied especially preferably by means of spraying.

In a development of this kind, the coating is applied by means of a spray method, so that what is known as a spray coating is formed. In this case, preferably, a layer is formed in that particles, when impinging onto the component surface, to be precise onto the surface of the inner or outer surface area of the piston housing or piston respectively are flattened to a specific degree as a function of the process and material and, as a result of mechanical clamping, are caught and build up a layer in plies.

In the spray method, the corresponding materials used are preferably high-strength plastics, such as polyetherketones, more preferably polyetheretherketones (PEEK). The coating has, in particular, low porosity, good binding to the surface of the piston or housing, that is to say good adhesive strength, and also, essentially, freedom from cracks and a homogeneous microstructure.

Moreover, the coating according to the disclosure is preferably formed from a film.

The film has, in particular, a thin configuration and is preferably formed from a high-strength plastic, such as from a polyetherketone, more preferably from a polyetheretherketone (PEEK). Here, too, the coating has, in particular, low porosity, good binding to the surface of the piston or housing, that is to say good adhesive strength, and also, essentially, freedom from cracks and a homogeneous microstructure.

The film is connected preferably in a materially integral manner, such as, for example, by adhesive bonding or vulcanizing, to the inner surface area of the piston housing and/or to the outer surface area of the piston. Furthermore, the film may also be pressed together with the corresponding surface area.

Furthermore, the object is achieved according to the disclosure by means of a method for producing a piston pump. The method comprises the following steps:
provision of a piston housing,
provision of a piston,
fixed application of a coating at least to an inner surface area of the piston housing or to an outer surface area of the piston, and
joining of the piston housing together with the piston to form a piston pump.

First, a piston housing and a piston are provided. Before the piston housing is joined together with the piston to form a piston pump, according to the disclosure a coating is applied fixedly, particularly according to the abovementioned features, to an inner surface area of the piston housing and/or to an outer surface area of the piston. This coating serves as a piston guide element during a pumping movement of the piston in the housing, that is to say during a movement of the piston in relation to the housing.

The coating is formed so as to be very thin, as compared with a conventional guide ring. That is to say, the coating is configured, in relation to a guide ring according to the prior art, as a thin layer or as a thin ply which is firmly connected to the surface area of the housing or of the piston.

The fixed application of the coating may take place by means of a positive, nonpositive and/or materially integral connection.

In the case of a positive connection, for example, the coating may be clamped on the surface area of the piston or of the housing.

In the case of a nonpositive connection, a normal force is exerted upon a connecting face between the coating and the inner surface area of the housing or the outer surface area of the piston in such a way that mutual displacement is prevented by static friction. Nonpositive connection may take place, in particular, by means of the coating being squeezed elastically into the interior of the piston housing or by the coating being stretched around the outer surface area of the piston.

In material integral connection, the coating and the piston housing or piston are held together by means of atomic or molecular forces, such as, for example, by means of adhesive bonding or vulcanizing.

One advantage of the method according to the disclosure is that the coating is first joined together with the piston housing and/or with the piston to form a unit or structural element. The piston and housing can consequently be assembled in a simple and cost-effective way to form the piston pump. It can be ensured furthermore, that the piston guide element in the form of a coating cannot be lost when the piston pump is being assembled. The assembly step according to the prior art, in which a conventional guide ring is pressed in between the housing and piston, is dispensed with. The production costs are thereby further reduced.

In the present case, the material used for the coating is preferably a high-strength plastic, such as a polyetherketone, more preferably a polyetheretherketone. Wear of the piston guide element when the piston pump is in operation is thus minimized and the lifetime or service life of the piston pump is optimized. Furthermore, when the piston pump is in operation, the piston is guided directly in the housing. It is fixed firmly in the piston housing and is held in the desired position during the pumping movement.

The fixed application of the coating preferably takes place by means of spraying.

In a development of this kind, the coating method used is a spray method, by means of which what is known as a spray coating is formed. During the spray process, preferably layer formation takes place, in that particles, when they impinge upon the component surface, to be precise upon the surface of the inner or outer surface area of the piston housing or piston respectively, are flattened to a specific degree as a function of the process and material and, as a result of mechanical clamping, are caught and build up a layer in plies.

Alternatively or additionally, the fixed application of the coating preferably takes place by means of the application of a film.

The film is, in particular, configured to be thin and is preferably connected in a materially integral manner, such as, for example, by adhesive bonding or vulcanizing, to the inner surface area of the piston housing and/or to the outer surface area of the piston. Furthermore, the film may also be pressed together with the corresponding surface area.

Finally, according to the disclosure, a piston guide element of this kind and also a vehicle brake system having a piston pump are provided.

The vehicle brake system according to the disclosure comprises a piston pump, preferably a hydraulic piston pump, having a piston guide element according to the disclosure in keeping with the features and advantages explained above.

A vehicle brake system of this kind may be, for example, an antilock system (ABS), a traction control system (TCS), and an electronic stabilization program (ESP), or else an eletrohydraulic brake system (EHB). In such brake systems, in particular, it is advantageous if the piston pump makes optimal function of the brake system available, along with a long running capacity or service life and requires a small installation space.

### BRIEF DESCRIPTION OF THE DRAWINGS

An exemplary embodiment of the solution according to the disclosure is explained in more detail below by means of the accompanying drawings in which:

FIG. 1 shows a partial longitudinal section through a hydraulic piston pump having a piston guide element according to the prior art, and

FIG. 2 shows a partial longitudinal section through a hydraulic piston pump having a piston guide element according to the disclosure.

### DETAILED DESCRIPTION

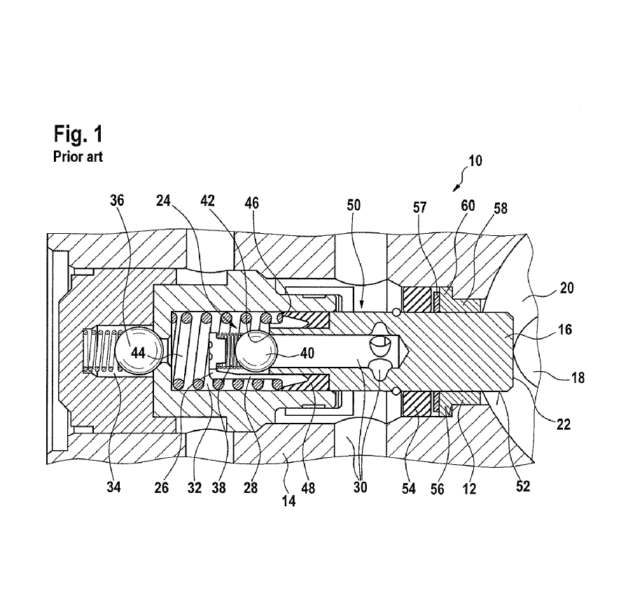

FIG. 1 shows a hydraulic piston pump 10 having a low pressure-side guide ring 12 as a piston guide element according to the prior art.

The piston pump 10 comprises a piston housing 14 and a piston 16 longitudinally displaceable axially in the piston housing 14. When the piston pump 10 is in operation, the piston 16 is driven by a rotating eccentric 18 which is arranged in an eccentric space 20. The eccentric 18 in this case bears with its outer circumference against an end face 22 of the piston 16 and causes the piston 16 to be retracted into an extended out of the piston housing 14.

The piston 16 is assigned an inlet valve 24. The inlet valve 24 is arranged in a valve housing 26 which is clamped to the piston 16 by means of a holding device 28. The inlet valve 24 is intended for sucking fluid by means of a lifting movement of the piston 16 through an inlet device 30 into a pressure region 32 inside the piston housing 14 and for conveying said fluid under pressure through an outlet 34 having an outlet valve 36 out of the pressure region 32 into a hydraulic system (not illustrated any further) for the purpose of performing work. The fluid is in the present case a brake fluid.

The valve housing 26 has a cup-shaped configuration as a cage, inside which is located a helical return spring 38 which pushes against a spherical closing body 40. The closing body 40 thereby bears against a valve seat 42 which is formed on the other end face of the piston 16.

The piston 16 is prestressed resiliently in the longitudinal direction by means of a return spring 44 arranged in the pressure region 32. The return spring 44 is supported at its left-hand end with respect to FIG. 1 on an end face of the piston housing 14 and pushes at its right-hand end against a spring support 46 which is formed as part of the valve housing 26. The spring support 46 is thus coupled fixedly to the piston 16, so that the return spring 44 pushes correspondingly against the piston 16 via the spring support 46.

When the piston 16 is pressed to the right with respect to FIG. 1 out of the piston housing 14 by means of the return spring 44, the closing body 40 of the inlet valve 24 is lifted off from the valve seat 42 counter to the force of the helical return spring 38, since a vacuum is built up in the housing 14. During this movement of the piston 16, the inlet valve 24 is opened and fluid is sucked into the pressure region 32 via the inlet device 30.

When the piston 16 is pressed to the left with respect to FIG. 1 into the housing 14 by means of the eccentric 18, the inlet valve 24 is closed, the outlet valve 36 is opened and the fluid is conveyed out of the pressure region 32 into the hydraulic system for the purpose of performing work.

Between the piston 16 and the housing 14 is arranged an annular sealing element 48, by means of which the pressure region 32 is sealed with respect to a low-pressure side 50. The sealing element 48 is pressed onto the piston 16 and bears axially against an outer surface area 52 of the piston 16. The sealing element 48 is held against this outer surface area 52 by means of the valve housing 26 clamped onto the holding device 28, in that the valve housing 26 engages positively and nonpositively into the sealing element 48.

On the low-pressure side 50, a low pressure-side sealing element 54 is arranged between an inner surface area 56 of the piston housing 14 and the outer surface area 52 of the piston 16. The low pressure-side sealing element 54 seals off, essentially fluid-tight, the eccentric space 20.

The guide ring 12 made from a suitable plastic is pressed in, next to a disk-shaped supporting ring 57, between the low pressure-side sealing element 54 and the eccentric space 20. The guide ring 12 is of L-shaped form as seen in longitudinal section, and bears axially with one leg 58 against the inner surface area 56 of the piston housing 14 and engages with another leg 60 into a recess of the housing 14 and is thereby clamped positively to the piston housing 14. The leg 58 is in this case pressed together in the piston housing 14. The leg 60 is supported axially on the piston housing 14. During retraction into an extension out of the housing 14, the piston 16 is guided and mounted by means of the guide ring 12. In this case, the piston 16 slides with its outer surface area 52 past the guide ring 12.

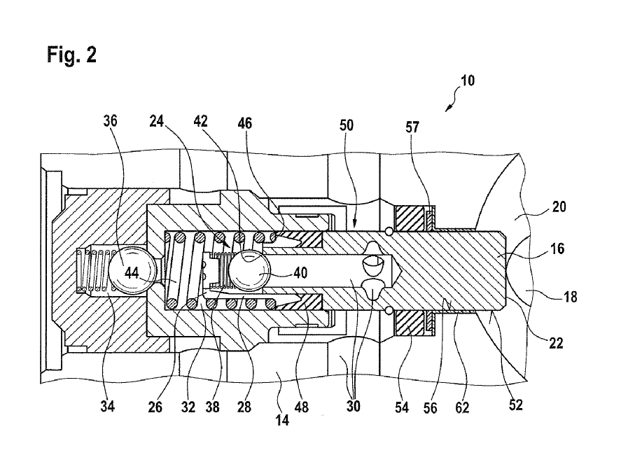

FIG. 2 illustrates the hydraulic piston pump 10 shown in FIG. 1. In this case, instead of the guide ring 12, a piston guide element 62 according to the disclosure is provided.

The piston guide element 62 is formed as an annular coating which is configured to be relatively thin with respect to the guide ring 12. The piston housing 14 is therefore drawn more deeply or more narrowly in the radial direction in the region in which the coating is arranged. A longer guide face is thus achieved axially by means of the piston guide element 62.

The coating is formed from a high-strength plastic, such as, for example, from polyetheretherketone, which is applied by means of a spray method or as a thin film to the inner surface area 56 of the piston housing 14. The high-strength plastic is thus applied in the form of a spray coating or film coating to the surface of an aluminum bore of the piston housing 14 or of the pump housing. The coating 62 is thus connected fixedly to the inner surface area 56 of the housing 14 and forms a unit with the piston housing 14.

The piston 16 can therefore be guided directly in the housing bore, and the guide ring 12 according to the prior art, in the form of an additional component, and also the step of assembling it may be dispensed with.

A wear-resistant piston guide in the piston housing 14 is thus provided by the application of a high-strength coating which optimally utilizes the available construction space. Optimal wear protection for the mounting of the piston 16 is also provided. Moreover, the guidance of the piston 16 in the piston housing 14 is provided over a larger length portion.

What is claimed is:

1. A piston pump, comprising:
a piston housing;
a piston movable in the piston housing; and
a piston guide element arranged between the piston housing and the piston, the piston guide element being configured for guiding and/or mounting the piston,
wherein the piston guide element is further configured as a coating applied fixedly at least to an inner surface area of the piston housing or to an outer surface area of the piston.

2. The piston pump according to claim 1, wherein the coating is formed from a high-strength plastic.

3. The piston pump according to claim 2, wherein the plastic is a polyetherketone.

4. The piston pump according to claim 1, wherein the coating is applied by spraying.

5. The piston pump according to claim 1, wherein the coating is formed by a film.

6. A method for producing a piston pump having a piston housing and a piston, comprising:
fixedly applying a coating at least to an inner surface area of the piston housing or to an outer surface area of the piston so as to form a piston guide element that is configured to guide and/or mount the piston; and
joining of the piston housing together with the piston so as to form the piston pump.

7. The method according to claim 6, wherein the fixedly applying step includes spraying the coating onto at least the inner surface area of the piston housing or the outer surface area of the piston.

8. The method according to claim 6, wherein the fixedly applying step includes applying a film onto at least the inner surface area of the piston housing or the outer surface area of the piston.

9. A piston guide element that is configured for guiding and/or mounting a piston moveable in a piston housing, wherein the piston guide element is configured as a coating applied fixedly to at least to an inner surface area of the piston housing or to an outer surface area of the piston.

10. A vehicle brake system including a piston pump, said piston pump, comprising:
a piston housing;
a piston movable in the piston housing;
a piston guide element arranged between the piston housing and the piston, the piston guide element being configured for guiding and/or mounting the piston,
wherein the piston guide element is further configured as a coating applied fixedly at least to an inner surface area of the piston housing or to an outer surface area of the piston.

11. The piston pump of claim 1, wherein the piston pump is configured as a hydraulic piston pump.
